(19) United States
(12) Patent Application Publication
(10) Pub. No.: US 2008/0224106 A1
(43) Pub. Date: Sep. 18, 2008

(54) PROCESS FOR TREATING COMPOSITIONS CONTAINING URANIUM AND PLUTONIUM

(76) Inventors: Michael Ernest Johnson, Richland, WA (US); Martin David Maloney, Evergreen, CO (US); Marty John Reibold, Louisville, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/851,932

(22) Filed: Sep. 7, 2007

Related U.S. Application Data
(60) Provisional application No. 60/843,461, filed on Sep. 8, 2006.
(60) Provisional application No. 60/922,037, filed on Apr. 4, 2007.

(51) Int. Cl. C09K 3/00

(52) U.S. Cl. 252/625

(57) ABSTRACT

Process for treating compositions containing uranium and plutonium, including spent nuclear fuel, are provided.

This application claims the benefit under 35 U.S.C. §119(e) of U.S. Provisional Application No. 60/843,461, filed Sep. 8, 2006 and U.S. Provisional Application No. 60/922,037, filed Apr. 4, 2007, each of which is incorporated herein by reference in its entirety.

### TECHNICAL FIELD

Processes for treating compositions containing uranium and plutonium are provided.

### BACKGROUND

Nuclear power plants generate spent nuclear fuel (SNF). SNF typically contains uranium, and other radioactive actinide elements such as neptunium, plutonium, americium and curium, radioactive rare earth elements, the radioactive transition metal technetium, as well as radioactive cesium and strontium. Generally, spent nuclear fuel contains both uranium and plutonium.

FIG. 1 sets forth a prior art plutonium uranium extraction (PUREX) process for treating SNF. The fuel is dissolved in nitric acid. After solvent extraction to separate uranium and plutonium from other fission products, the uranium and plutonium mixture is partitioned and uranyl nitrate with fission products and other contaminants is purified and converted to its oxide, UO₃. Similarly, plutonium nitrate is purified separately and either converted to metal for weapons production or converted to its oxide, PuO₂ which is then used to fabricate nuclear fuel.

The PUREX process separates plutonium from uranium and other radionuclides present in SNF. As a consequence, there is an increased risk in the proliferation of plutonium and the generation of weapons of mass destruction if the PUREX process is used.

Two different nuclear fuel cycle processes have been developed. “Spent fuel recycling” is a process whereby the spent fuel is processed and uranium and plutonium are reused back through the reactors. (statement of Dennis Spurgeon to the Subcommittee on Energy and Water Appropriations, Sep. 14, 2006). “Once-through fuel cycling” is the process whereby the fuel is used once and then discarded without further processing. Since the 1970's, the U.S. has used a once-through fuel cycle and does not separate out plutonium. However, Russia, Japan, France, Great Britain and others engage in spent fuel recycling, resulting in a separated civilian plutonium buildup of almost 250 metric tons. (see also U.S. Dept. of Energy Report to Congress: Spent Nuclear Fuel Recycling Program Plan, May 2006, notably §3.6). As such, there has been a longstanding risk of the continued increase of separated plutonium from a variety of technologies related to fuel cycle separation.

There is therefore a longstanding need in the art for methods of processing compositions containing uranium and plutonium, but without producing fissionable materials. This and other needs are addressed by the present disclosure.

### SUMMARY

In one aspect, methods of treating compositions comprising uranium and plutonium, such as spent nuclear fuel and nuclear waste are provided. The processes separate a high percentage of components suitable for reuse as new fuel for energy purposes, while rendering the remaining compositions unsuitable for reuse in the creation of nuclear weapons. The process is achieved by producing plutonium in combination with uranium, which may in turn be converted for reuse as new fuel.

In a further aspect, plutonium and uranium are removed as a mixture. First, a plutonium and uranium-containing composition is dissolved in an acidic solution in the presence of a reducing agent that reduces Pu⁺⁶ to Pu⁺⁴ and an oxidizing agent that oxidizes Pu⁺³ to Pu⁺⁴. Second, the U⁺⁶ and Pu⁺⁴ are extracted from the acidic solution with an organic solvent that binds U⁺⁶ and Pu⁺⁴ to form U⁺⁶ and Pu⁺⁴ complexes soluble in the organic solvent. The solvent may optionally be combined with a diluent. Third, the U⁺⁶ and Pu⁺⁴ are then back-extracted from the organic solvent with a dilute acidic solution. Fourth, a mixture of U⁺⁶ and Pu⁺⁴ is precipitated by adding a precipitation agent such as carboxylic acid, peroxide, or fluoride to the acidic acid solution, thereby removing uranium and plutonium. The foregoing results in a mixture of plutonium and uranium oxide which is not directly useful to make nuclear weapons.

In certain specific embodiments, the acidic solution of step (1) comprises 1-4M nitric acid, the organic solvent of step (2) comprises tributyl phosphate, the back-extracting of U⁺⁶ and Pu⁺⁴ from the organic phase in step (3) is with 0.1 M nitric acid, and the carboxylic acid used in step (4) is oxalic acid. In certain embodiments, the tributyl phosphate solvent is dissolved in a diluent to modify the viscosity and the density relative to the acid solution of step (1) to improve separation of the acid and solvent phases after mixing. The diluent used in step (2) is n-dodecane or similar hydrocarbon mixtures.

The process can also be used to form a metal oxide mixture of UO₃, PuO₂ and NpO₂. Neptunium (Np⁺⁵) is also present in SNF. In order to include NpO₂ in the mixed metal oxide, the acid solution of step (1) should contain a low nitrite concentration, such as less than 0.01 M nitrite. The Np⁺⁵ is oxidized to Np⁺⁶ by nitrite when an acid (e.g. 1-6M nitric acid) is used in step (1). The Np⁺⁶ is then extracted into the organic solvent with U⁺⁶ and Pu⁺⁴. The Np⁺⁶, is back extracted from the organic solvent (step 3) by increasing the nitrite concentration, for example to greater than 0.01 M. It is then reduced to Np⁺⁴ using, for example, hydrazine. The solution is then heated to decompose the hydrazine, and then co-precipitated with the U⁺⁶ and Pu⁺⁴ during precipitation step (4). The precipitate is then calcined to form the metal oxide mixture of UO₃, PUO₂ and NpO₂. This mixture can be used to fabricate new fuel.

The disclosure further provides processes to separate technetium (a beta emitter with a half-life of approximately 210,000 years) from spent nuclear fuel. Technetium can be separated as described above, and can either be retained or immobilized for storage. The acid solution of step (1) contains Tc⁺⁷ which is extracted with the U⁺⁶ and Pu⁺⁴ during the solvent extraction of U⁺⁶ and Pu⁺⁴ in step (2). The Tc⁺⁷ is back-extracted from the organic solvent with a strong acid solution (e.g. 6M nitric acid). The U⁺⁶ and Pu⁺⁴ are then back-extracted from the organic solvent using a dilute acid solution (e.g. 0.1 M nitric acid).

### BRIEF DESCRIPTION OF THE DRAWINGS

Those skilled in the art will understand that the drawings, described herein, are for illustration purposes only. The drawings are not intended to limit the scope of the present disclosure.

FIG. 1 is a flow diagram for the traditional PUREX process to separate plutonium and uranium and then plutonium from uranium.

FIG. 2 is a flow diagram showing a modified PUREX process wherein uranium and plutonium are separated from radionuclides to form a mixed oxide of plutonium and uranium.

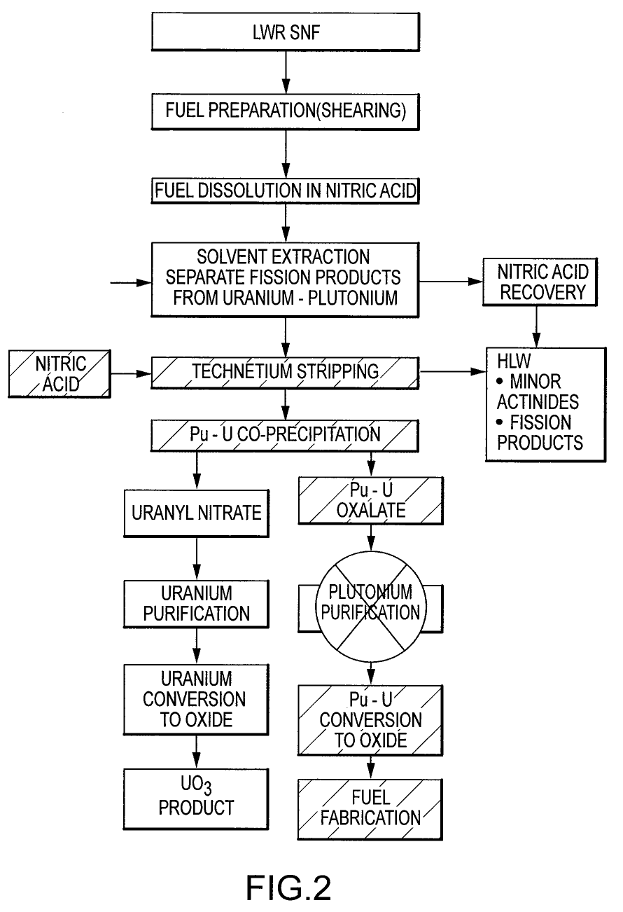

FIG. 3 depicts the solubility relationship between plutonium concentration and nitric acid concentration.

FIG. 4 depicts the extent of uranium and plutonium precipitation at 90 minutes as a function of the ratio of oxalic acid to plutonium in 1.14 molar HNO₃.

FIG. 5 depicts the extent of uranium and plutonium precipitation at 90 minutes as a function of the ratio of oxalic acid to plutonium in 2.00 molar HNO₃.

FIG. 6 depicts the extent of uranium and plutonium precipitation at 90 minutes as a function of the ratio of oxalic acid to plutonium in 3.00 molar HNO₃.

FIG. 7 depicts an exemplary method of processing spent nuclear fuel.

### DETAILED DESCRIPTION

The disclosure is directed to methods of simultaneously removing uranium and plutonium from a uranium and plutonium composition. This process is referred to as PUREX-NPC™. A plutonium and uranium-containing composition is dissolved in an acidic solution in the presence of a reducing agent that reduces Pu⁺⁶ to Pu⁺⁴ and an oxidizing agent that oxidizes Pu⁺³ to Pu⁺⁴. The U⁺⁶ and Pu⁺⁴ are extracted from the acidic solution with an organic solvent that binds U⁺⁶ and Pu⁺⁴ to form U⁺⁶ and Pu⁺⁴ complexes soluble in the organic solvent. The U⁺⁶ and Pu⁺⁴ are then back-extracted from the organic solvent with an acidic solution. A mixture of U⁺⁶ and Pu⁺⁴ is precipitated by adding a precipitation agent such as carboxylic acid, peroxide, or fluoride to the acidic acid solution, thereby removing uranium and plutonium.

The uranium and plutonium-containing compositions can be from any source. Typically, uranium and plutonium containing compositions are from irradiated nuclear compositions such as SNF from a light water reactor (LWR). The plutonium and uranium can be treated in the context of processing nuclear waste. The compositions may or may not be fissionable material.

First, the composition containing uranium and plutonium is dissolved in an acidic solution. The acid solution can be any acid solution known in the art. Exemplary acids include hydrochloric acid and nitric acid. Acids can include anions that complex plutonium (e.g. sulfate, phosphate, fluoride, hydroxyl, and oxalate anions) are generally disfavored because they complex tetravalent plutonium. Acids are further discussed in U.S. Pat. No. 2,882,124, incorporated herein by reference in its entirety. In certain preferred embodiments, the acid is nitric acid.

The acid can have any concentration suitable for dissolving the uranium and plutonium containing composition. In certain embodiments, the acid concentration can be greater than and/or less than a specific acid molarity. For example, acid concentration can be greater than and/or equal to 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, or 5.0 molar solution. The acid concentration can be less than and/or equal to a molarity 5.0, 4.8, 4.6, 4.4, 4.2, 4.0, 3.8, 3.6, 3.4, 3.2, 3.0, 2.8, 2.6, 2.4, 2.2, 2.0, 1.8, 1.6, 1.4, 1.2, 1.0, 0.9, 0.8, 0.7, 0.6 molarity. In certain embodiments, the acid concentration can be greater than or equal to 1 M solution, and less than or equal to 4 M solution.

The acid solution contains a reducing agent that reduces plutonium to the +4 valence state (Pu⁺⁴). The reducing agent reduces Pu⁺⁶ to Pu⁺⁴. Exemplary reducing agents include the ferrous sulfamate, hydroxylamine nitrite, sodium nitrite, nitrous acid, and acetohydroxamic acid.

If nitric acid is used to dissolve the plutonium and uranium composition, the reducing agent is the nitrite ion, the plutonium is reduced according to the following reaction:

PuO₂(NO₃)₂+NaNO₂+2HNO₃→Pu(NO₃)₄+NaNO₃+H₂O

### See RHO-MA-116, p. 6-9, 1982, PUREX Technical Manual, Rockwell Hanford Operations, Richland, Wash.

The acid solution also contains an oxidizing agent which oxidizes Pu⁺³ to Pu⁺⁴. Exemplary oxidizing agents include nitrous acid, ozone, hydrogen peroxide, potassium permanganate, sodium dichromate, sodium nitrite, and nitrogen dioxide. In certain embodiments, the oxidizing agent can be uranium of a specific valence, such as U⁺⁶. The U⁺⁶ is often present as uranyl compounds, such as uranyl nitrate when the acid is nitric acid. See RHO-MA-116, p. 5-18 through 5-20 and 6-9.

When nitric acid is used as the acid, the nitrate ion acts as a salting-out agent in the solvent extraction process to enhance plutonium and uranium extraction by the organic solvent. In other aspects, other salting-out agent can be added to the acid solution. Generally, the “salting out” agents have high solubility in the solution to be extracted and low solubility in the extract phase. Preferably, salting out agents have a common ion with the compound being extracted. When nitrates of plutonium and uranium are extracted, then the salting agent is preferably inorganic nitrate. Salting-out agents can include nitrate salts, including but not limited to NaNO₃, KNO₃, LiNO₃, NH₄NO₃, Mn(NO₃)₂, Ca(NO₃)₂, Sr(NO₃)₂, Mg(NO₃)₂, La(NO₃)₃, and AI(NO₃)₃. Other nitrate salts have been used as salting agents and other organic compounds have been used in the solvent extraction of plutonium and other metals, as described in U.S. Pat. Nos. 2,882,124, Apr. 14, 1959, Solvent Extraction Process for Plutonium, No. 2,918,349, Dec. 22, 1959, Extraction of Plutonium Values from Organic Solutions, and No. 2,950,166, Aug. 23, 1960, Method for Separation of Plutonium from Uranium and Fission Products by Solvent Extraction.

The U⁺⁶ and Pu⁺⁴ are extracted from the acidic solution with an organic solvent, forming U⁺⁶ and Pu⁺⁴ complexes that are soluble in the organic solvent. In various embodiments, the organic solvents contain at least one atom capable of donating an electron pair to a coordination bond. For example, solvents contain an oxygen, sulfur, or nitrogen electron-donor atom.

The organic solvent can be any organic solvent known in the art. Solvents include branched or unbranched hydrocarbons (C₁₂-C₂₀ in any mixture), ketones, aryls, substituted aryls, ketones, oxides, and the like. Specific examples of solvents include ethyl ether, bis-β-chloroethyl ether, 2-phenoxyethanol, 2-benzyloxyethanol, 2-(β-ethylbutoxy)ethanol, 1,2-diethyoxyethane, 1-ethoxy-2-butoxyethane, bis-β-butoxethyl ether, 1,-bis-(β-chloroethyoxy) ethane, 5,8,11,14,17-pentoxaheneicosane, o-nitroanisole, 2,6-dimethyl-1,4-dioxane, 1-oxa,-2,5-dimethylcyclopentane, ethyl sulfide, hexanol, heptanol, heptadecanol, 2-ethylbutanol, methylisobutulcarbinol, methyl ethyl kentone, methyl amyl ketone, methyl isobutyl ketone, mesityl oxide, acetophenone, cyclopentanone, cyclohexanone, 4-methylcyclohexanone, menthone, isophorone, nitromethane, nitroethane, 1-nitropropane, nitrobenzene, and tributyl phosphate. In certain embodiments, the solvent tributyl phosphate (TBP) dissolved in N-dodecane or similar hydrocarbon diluents can be used.

The uranium and plutonium in solution combine with the solvent to form a complex. In the case of TBP, the hydrogen is replaced with U or Pu.

Addition of the organic solvent allows plutonium and uranium to be co-extracted into the solvent phase. If TBP is the added solvent, the following reactions occur, leaving the minor actinides and almost all of the fission products in the aqueous phase.

Pu⁺⁴+4NO₃⁻+2TBP(org)→Pu(NO₃)₄·2TBP(org)

UO₂⁺²+2NO₃⁻+2TBP(org)→UO₂(NO₃)₂·2TBP(org)

### See RHO-MA-116, p. 6-4.

The U⁺⁶ and Pu⁺⁴ are then simultaneously back-extracted from the organic solvent by adding a dilute acidic aqueous solution. The dilute acidic aqueous solution causes the uranium nitrate and plutonium nitrate to re-enter the aqueous phase.

The acid solution can be any acid known in the art, including nitric acid. The acid solution is sufficiently concentrated such that the plutonium complexes do not polymerize. In various embodiments, the molarity of the acid solution is less than or equal to 0.30, 0.28, 0.26, 0.24, 0.22, 0.20, 0.18, 0.16, 0.14, 0.12. In various other alternatives, the molarity can also be greater than or equal to 0.10, 0.12, 0.14, 0.16, 0.18, 0.20, 0.22, 0.24, 0.26, or 0.28.

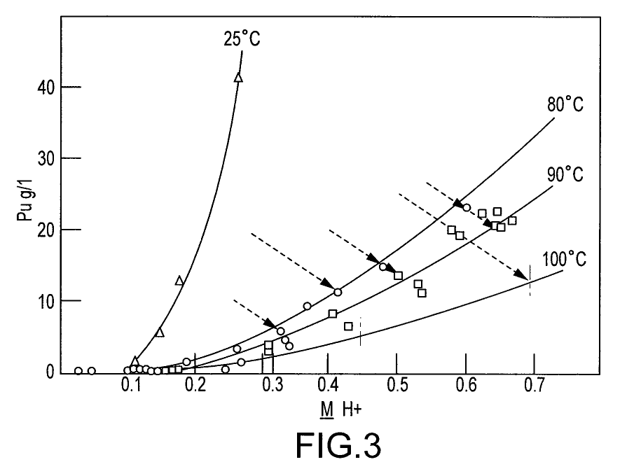

FIG. 3 shows the solubility of plutonium in nitric acid (see HW-54203, p. 17, 1957, Polymerization and Precipitation of Plutonium (IV) in Nitric Acid, General Electric Company, Richland Wash.). The plutonium solution forms a polymer in the region shown to the left of each of the temperature curves. For example, a 10-gm/L Pu solution forms a polymer at 0.1 M acidity at 25° C., but not at >0.2M acidity and 25° C.

In various aspects, the methods disclosed herein plutonium concentration is between about 1 g/L and 3 g/L.

The mixture of U⁺⁶ and Pu⁺⁴ is then precipitated by adding a precipitation agent. Carboxylic acids, fluoride and peroxide are examples of suitable precipitation agents. Numerous carboxylic acids are known in the art. In certain embodiments, the carboxylic acid is oxalic acid. Both Pu and U substituted for the labile hydrogen on the carboxylic acid. Alternatively, fluoride can be added as a precipitation agent to produce plutonium fluoride and uranium fluoride. In an additional embodiment, peroxide can be added as a precipitation agent to form UO₄ and PuO₄.

The precipitate can be calcinated to form a mixed metal oxide comprising PuO₂ and UO₃. The mixed metal oxide can be converted into fuel. The supernatant of the precipitant can be U⁺⁶ calcinated to produce UO₃.

The methods provided herein can be adapted to allow additional radioactive components to be removed. For example, Tc⁺⁷ can be removed from the solution in the first acid extraction step, then extracted in the organic phase, and finally back-extracting Tc⁺⁷ from said solution with an acid solution before the uranium and plutonium are back-extracted.

Similarly, Np⁺⁵ can be extracted. When the acid solution initially contains a very low concentration of nitrite, (e.g. less than about 0.01 M nitrite), the Np⁺⁵ is oxidized to Np⁺⁶, and extracted into the organic solvent. The Np⁺⁶ can then be reduced to Np⁺⁴ using a reducing agent such as hydrazine, and co-precipitated with said U⁺⁶ and Pu⁺⁴ during the U⁺⁶ and Pu⁺⁴ precipitation step. The co-precipitated uranium, plutonium, and optionally other elements such as neptunium, can be calcined to a mixed metal oxide of UO₃, PUO₂ and NpO₂.

Technetium is known to co-extract into the solvent. Technetium is removed (i.e. back-extracted) from the solvent in the PUREX-NPC™ process using concentrated nitric acid. Technetium back-extracted from the solvent is a well understood process. Researchers at the Japan Atomic Energy Research Institute and Savannah River National Laboratory in South Carolina have demonstrated technetium back-extraction using variants of the PUREX process, including those described in Technetium Separations for Future Reprocessing, 2005, T. Asakura et al, Journal of Nuclear and Radiochemical Sciences, Vol. 61, No. 3, p 271-274; and WSRC-TR-2002-00444, 2002, Demonstration of the UREX Solvent Extraction Process with Dresden Reactor Fuel Solution, M. C. Thompson et al, Westinghouse Savannah River Company, Aiken S.C.

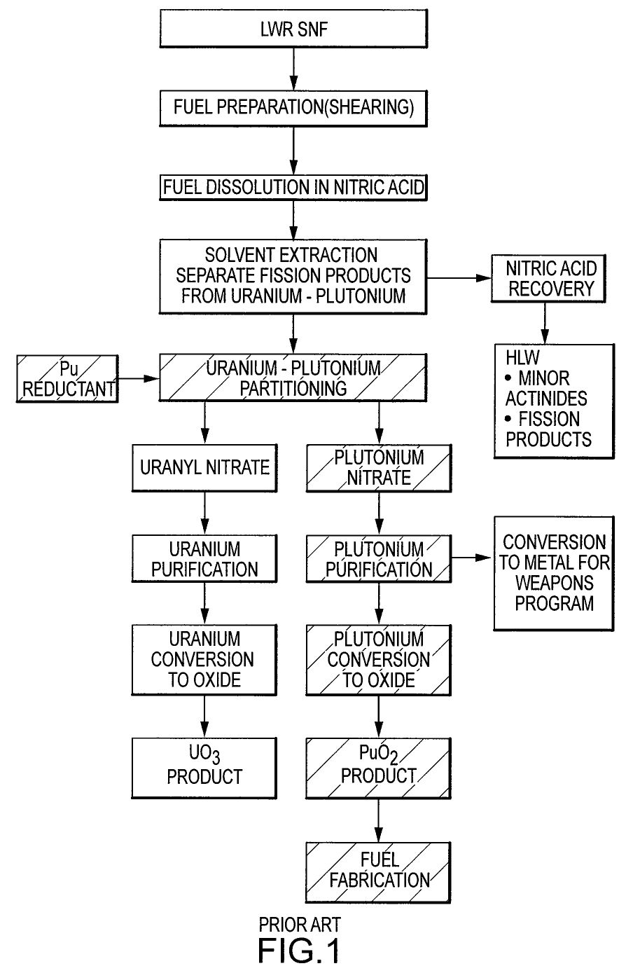

Unlike the present disclosure, other processes reduce plutonium to the +3 valence (Pu⁺³) stage using a reductant such as ferrous sulfamate, as shown in the following reactions. The sulfamic acid prevents nitrite from oxidizing Pu⁺³ to Pu⁺⁴, thereby allowing plutonium to be separated from uranium. See FIG. 1.

Pu(NO₃)₄·2TBP_{(org)}+Fe⁺²→2TBP_{(org)}+Pu(NO₃)₃+Fe⁺³

HNO₂+NH₂SO₃⁻→N₂+H⁺+SO₄⁻²+H₂O

The methods disclosed herein do not separate plutonium from uranium. Instead, plutonium and uranium are stripped together from the solvent using dilute (approximately 0.1M) nitric acid. In the PUREX-NPC™ process, plutonium is co-precipitated with a small amount of uranium by addition of oxalic acid as indicated by the following reactions:

Pu(NO₃)₄+2 H₂C₂O₄+6 H₂O→Pu(C₂O₄)₂+4 HNO₃

UO₂(NO₃)₂+H₂C₂O₄+3 H₂O→UO₂(C₂O₄)·3 H₂O+2 HNO₃

The majority of the uranium remains in solution and is separated from the oxalate precipitate. Complete separation of the uranium solution from the oxalate precipitate is not necessary, since any remaining solution will not interfere with the subsequent calcination of the oxalate precipitate to form plutonium oxide and uranium oxide.

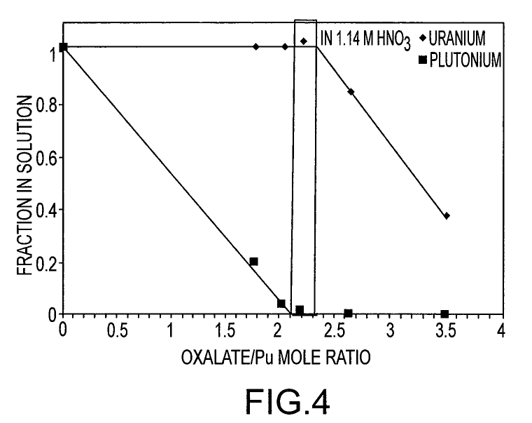

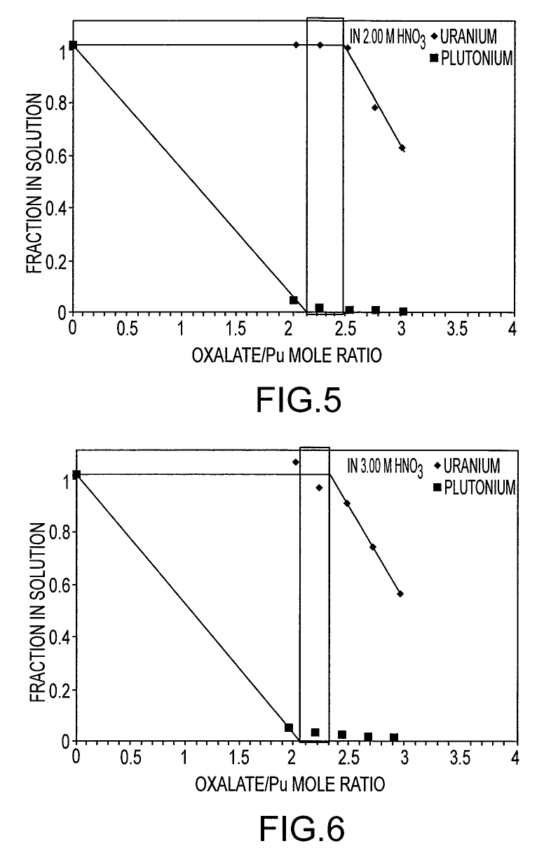

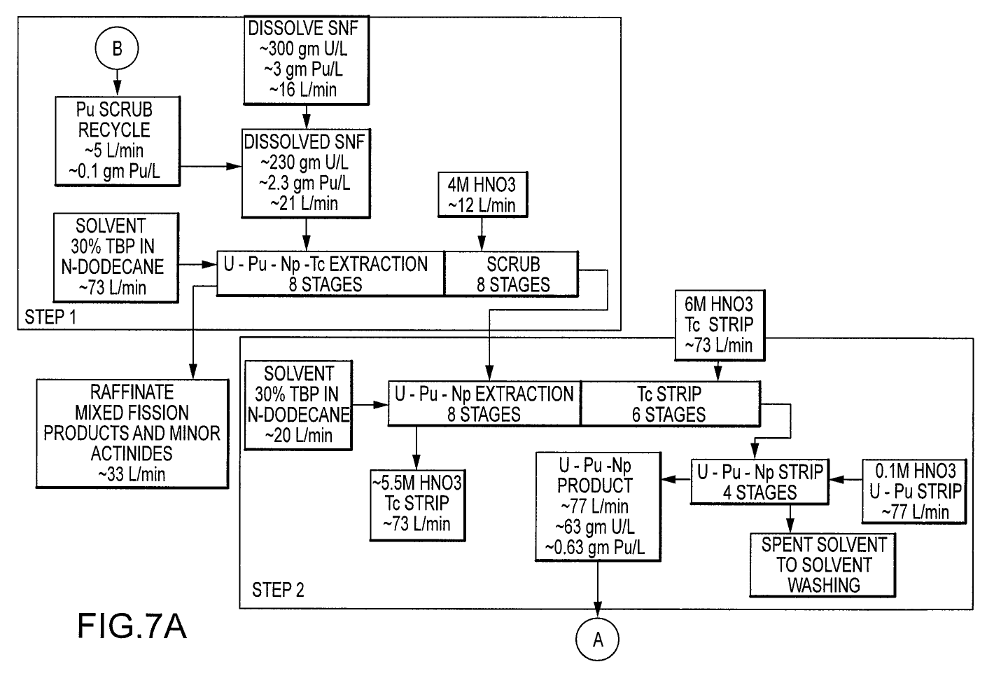

FIGS. 4-6 show the extent of uranium and plutonium precipitation at 90 minutes as a function of the ratio of oxalate to plutonium under various conditions. As can be seen under the conditions employed, most of the plutonium precipitates as an oxalate when the mole ratio of oxalic acid to plutonium approaches 2.1. The bulk of the uranium remains in solution at this ratio. The uranium begins precipitating when the oxalate to plutonium mole ratio is greater than 2.3. An increase in the oxalate to plutonium mole ratio above 2.3 results in additional precipitation of uranium oxalate with the already precipitated plutonium oxalate. The ratio of uranium to plutonium oxalate can be readily adjusted by increasing or decreasing the oxalate to plutonium mole ratio.

In a preferred embodiment, the plutonium content of the final mixed oxide is 10-20 wt %, although the amount of plutonium can be as high as 90%.

The carboxylic acid co-precipitation and subsequent calcination of plutonium with varying amounts of uranium was recently demonstrated at the Hanford site in Richland Wash., see PNNL-13934, 2002, Critical Mass Laboratory Solutions Precipitation, Calcination, and Moisture Uptake Investigations, C. H. Delegard et al, Pacific Northwest National Laboratory, Richland Wash. The mixed plutonium and uranium caboxylate (e.g. plutonium and uranium oxalate) precipitate is calcined and converted to a mixed oxide powder. Any residual uranyl nitrate dissolved in the interstitial liquid of the oxalate precipitate is also converted to uranium oxide.

The mixed plutonium and uranium oxide can be fabricated into fuel for use in commercial reactors. Trace plutonium can remain in the uranyl nitrate solution and is removed by reducing the Pu⁺⁴ to Pu⁺³ valence state by addition of hydroxylamine nitrate (or other suitable reductant). The uranyl nitrate solution is extracted using the organic solvent (e.g. N-dodecane and tri-butyl phosphate) to separate the Pu⁺³ from uranium. Dilute nitric acid (˜0.3M) is used to scrub the solvent to remove any Pu co-extracted. The raffinate stream, containing Pu⁺³, is transferred to the spent fuel dissolvers, where the Pu⁺³ is oxidized to Pu⁺⁴, mixed with a fresh batch of dissolved fuel and becomes part of the feed to the PUREX-NPC™ process. Uranium is stripped from the solvent using dilute nitric acid (˜0.01 M).The uranyl nitrate solution is then calcined separately to convert uranium to an oxide.

### EXAMPLE

The following example illustrates aspects of the disclosure. It will be apparent to those skilled in the art that many modifications, both to materials and methods, may be practiced without departing from the scope of the disclosure.

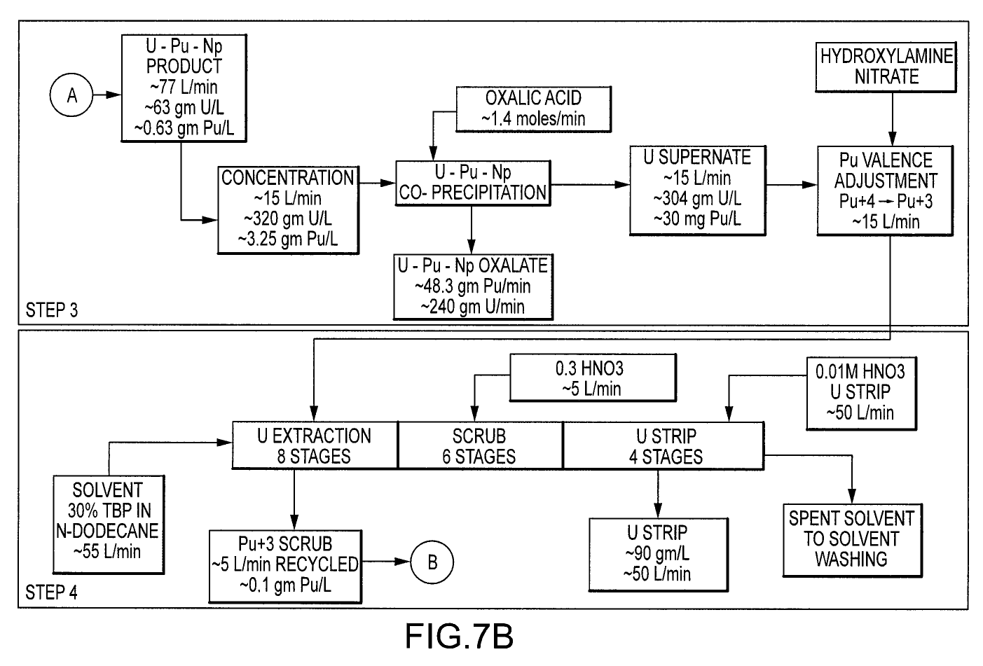

FIG. 7 depicts the features of the an exemplary method of processing spent nuclear fuel. Centrifugal contactors, pulsed columns or mixer settlers can be used for each of the stages shown in each of the processing steps in FIG. 7. The number of stages shown for each of the processing Steps can be varied to optimize process conditions and the concentrations of products in each of the streams. The values provided in FIG. 7 are typical for irradiated spent nuclear fuel, but other values may also be processed by the PUREX-NPC™ process.

In Step 1 of FIG. 7, the dissolved spent nuclear fuel (or any uranium and plutonium composition) is fed along with a plutonium scrub recycle stream to the extraction step and contacted with tri-butyl phosphate in n-dodecane. Plutonium, uranium, technetium and neptunium are extracted by the organic solvent. If neptunium extraction is not desired, the nitrite concentration in the dissolved spent nuclear fuel is increased above 0.01 molar.

Some of the minor actinides (e.g. americium and curium) and fission products (e.g. cerium and lanthanum) are also extracted by the organic solvent, but are removed in the Scrub section of Step 1 by counter contacting with a moderate (e.g. 4 molar) concentration of nitric acid. The acidic aqueous solutions in Step 1 are combined and exit the Extraction section as a raffinate, which contains the mixed fission products and minor actinides originally present in the dissolved spent fuel. This raffinate may be further treated or discarded as waste.

The uranium, plutonium, neptunium, and technetium that are co-extracted into the organic solvent in Step 1 are processed in Step 2 to separate technetium. This is accomplished by contacting the uranium, plutonium, neptunium, and technetium in organic solvent with 6 molar nitric acid to strip technetium from the organic solvent. Some of the uranium, plutonium and neptunium may also be stripped from the organic solvent by contacting with the nitric acid solution, but technetium is re-extracted in Step 2 by contacting fresh organic solvent. The organic solvent, containing uranium, plutonium, and neptunium, is contacted with a dilute nitric acid solution (e.g. 0.1 molar) to strip these materials from the organic solvent.

As shown in Step 3, the uranium, plutonium, and neptunium in the acidic strip solution from Step 2 are heated to 60° C. to reduce neptunium to valence state +4 by use of hydrazine. See RHO-MA-116, p. 8-5, PUREX Technical Manual, 1980, Rockwell Hanford Company, Richland Wash. Equipment used for heating the acidic strip solution can be any standard commercial equipment such as a heating jacketed vessel, a heat exchanger, or an evaporator. Heating the acidic strip solution also serves to remove excess nitric acid solution and to adjust the nitric acid concentration. The acidic strip solution is then cooled to below 25° C. and then mixed with oxalic acid to co-precipitate plutonium, neptunium, and some of the uranium. The majority of the uranium remains in solution and is separated from the oxalate precipitate using standard equipment such as filters or centrifuges. Complete separation of the uranium solution from the oxalate precipitate is not necessary, since any remaining solution will not interfere with the subsequent calcination of the oxalate precipitate.

A small amount of plutonium remains in the uranium solution following the oxalate precipitation in Step 3. The concentration of the soluble plutonium in the uranium solution is controlled by the solution temperature and nitric acid and oxalic acid concentrations of the solution. See RHO-MA-116, p. 1-41 thru 1-46, PUREX Technical Manual, 1980, Rockwell Hanford Company, Richland Wash. The nitric acid concentration should be less than 1.0M and the excess oxalic acid concentration should be equal to or greater than 0.005M to minimize the soluble plutonium concentration. A lower solution temperature results in a lower soluble concentration of plutonium. At 27° C., 0.5M nitric acid and 0.005M excess oxalic acid, the soluble plutonium concentration is ˜1×10⁻⁴ M (˜25 to 30 mg/L). The uranium, plutonium and neptunium oxalate precipitate can be further processed by calcining to convert the uranium, plutonium and neptunium to oxides.

The uranium and small quantity of plutonium remaining in solution following the oxalic acid precipitation is mixed with hydroxylamine nitrate to reduce plutonium from valence state +4 to +3. The reduced plutonium and uranium are then processed in Step 4 to separate uranium from the plutonium (+3 valence state).

In Step 4, the mixture of uranium and plutonium (+3 valence state) are contacted with fresh organic solvent to extract uranium into the solvent, while leaving the plutonium (+3 valence state) in the aqueous phase. The plutonium (+3 valence state) containing aqueous phase is recycled to Step 1 for recovery of plutonium. The uranium extracted into the organic solvent is stripped using dilute nitric acid (e.g. 0.01 molar). The recovered uranium nitric acid solution can be further processed by calcining to convert the uranyl nitrate to uranium oxide.

All publications, patents, and patent applications cited herein are hereby incorporated by reference in their entirety for all purposes to the same extent as if each individual publication, patent, or patent application were specifically and individually indicated to be so incorporated by reference. Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit and scope of the appended claims.

It should be noted that there are alternative ways of implementing the embodiments disclosed herein. Accordingly, the present embodiments are to be considered as illustrative and not restrictive, and the claims are not to be limited to the details given herein, but may be modified within the scope and equivalents thereof.

What is claimed is:

1. A process for simultaneously removing uranium and plutonium from a uranium and plutonium-containing composition comprising the steps of:
(a) dissolving said uranium and plutonium-containing composition in an acidic solution in the presence of a reducing agent that reduces Pu⁺⁶ to Pu⁺⁴ and an oxidizing agent that oxidizes Pu⁺³ to Pu⁺⁴;
(b) extracting said U⁺⁶ and Pu⁺⁴ from said acidic solution with an organic solvent that binds U⁺⁶ and Pu⁺⁴ to form U⁺⁶ and Pu⁺⁴ complexes that are soluble in said organic solvent;
(c) back-extracting U⁺⁶ and Pu⁺⁴ simultaneously from said organic solvent with an acidic aqueous solution; and
(d) precipitating a mixture of U⁺⁶ and Pu⁺⁴ by adding a carboxylic acid to acidic aqueous solution.

2. The process of claim 1 further comprising calcining said precipitate to form a mixed metal oxide of PuO₂ and UO₃.

3. The process of claim 2 further comprising fabricating said mixed metal oxide into fuel.

4. The process of claim 1 wherein the supernatant of said precipitating step (d) comprises U⁺⁶ and said process further comprises calcining said supernatant to form UO₃.

5. The process of claim 1 wherein the nitric acid solution remaining after said extracting of step (b) contains Np⁺⁵ when the nitrite anion concentration exceeds 0.01 M.

6. The process of claim 1, wherein
said acidic solution of step (a) further comprises Tc⁺⁷,
said step (b) further comprises extracting Tc⁺⁷ into said solution comprising organic acid, and
said method further comprises a step of adding a strong acid to back-extract Tc⁺⁷ from said solution before said step (c).

7. The process of claim 6, wherein said strong acid is 6M nitric acid.

8. The process of claim 1, wherein the organic solvent is tri-butyl phosphate in N-dodecane diluent.

9. The process of claim 1 wherein said acid solution of step (a) contains less than 0.01 M nitrite and initially comprises Np⁺⁵, wherein said Np⁺⁵ is oxidized to Np⁺⁶ by nitrite and extracted in step (b) into said solution comprising organic solvent.

10. The process of claim 9 wherein said Np⁺⁶ is reduced to Np⁺⁴ using hydrazine and heat and then co-precipitated with said U⁺⁶ and Pu⁺⁴ during said precipitating step (d).

11. The process of claim 10 further comprising calcining the co-precipitates to form a mixed metal oxide of UO₃, PuO₂ and NpO₂.

12. The process of claim 1, further comprising:
e) adding a reductant to said uranyl nitrate solution to reduce Pu⁺⁴ to Pu⁺³;
f) adding a second organic solvent to separate Pu⁺³ from uranium;
g) adding dilute acid solution to the second organic solvent to remove Pu⁺³;
h) oxidizing Pu⁺³ to Pu⁺⁴;
i) combining the Pu⁺⁴ with spent nuclear fuel; and
j) calcinating uranium to uranium oxide.

13. The process of claim 12, wherein said second organic solvent is tri-butyl phosphate in N-dodecane diluent.
